(19) United States
(12) Patent Application Publication
(10) Pub. No.: US 2005/0256224 A1
(43) Pub. Date: Nov. 17, 2005

(54) Colored material and method for producing the colored material

(75) Inventors: Hirokatsu Miyata, Kanagawa (JP); Akira Kuriyama, Kanagawa (JP); Miki Ogawa, Kanagawa (JP); Tomonari Horikiri, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/515,205

(22) PCT Filed: May 16, 2003
(86) PCT No.: PCT/JP03/06124

§ 371 Date: Nov. 22, 2004

(30) Foreign Application Priority Data
May 24, 2002 (JP) 2002-150568

(51) Int. Cl. C03C 17/00; C09D 11/00

(52) U.S. Cl. 523/160; 523/161

(57) ABSTRACT

A coloring material (11, 12) carrying an anionic dye (15) on porous silica (16) having mesopores (13) of a uniform size, of which at least a part of the surface is covered with a material (14) capable of binding an anionic substance. The coloring material shows vivid color and is applicable to ink, electrophoretic particles and color filters.

### TECHNICAL FIELD

The present invention relates to coloring materials and producing methods therefor.

### BACKGROUND ART

With the recent progress in digital information equipment such as computers, importance of printing and display apparatuses is increasing as the output apparatus thereof, and higher performance and more complex functions are demanded. Specifically, more vivid color reproducing ability is requested for both printers and displays, and printing with higher weather resistance is requested for printers, while lower electric power consumption and a thinner structure are requested for displays. Researches and developments are actively conducted to meet these requirements for printers and displays.

In the field of the printing apparatus, improvement of inks is continued in order to meet the aforementioned requirements, together with the improvement in the hardware, e.g., small size and high density of the ink discharging nozzles and the improvement in the softwares such as printer-driving algorithm. For example, Japanese-Patent Application Laid-Open No. H08-039795 proposes a method of depositing a colorless ink and depositing thereon a colored ink thereby causing a reaction of the two on a plain paper to improve the water resistance. Also Japanese Patent Application Laid-Open No. 2001-199151 proposes a method of depositing an aqueous ink on the surface of charged particles, thereby suppressing blotting or color mixing (bleeding) phenomenon.

Also in the field of display apparatus, reflective display apparatuses are expected from the standpoint of lower electric power consumption and lower burden to eyes. As one of such apparatuses, there is known an electrophoretic display apparatus invented by Harold D. Lees et al. (U.S. Pat. No. 3,612,758). FIG. 3 shows the structure of such an electrophoretic display apparatus and an operation principle thereof. This apparatus is constituted of charged electrophoretic particles 31, an electrophoretic dispersion medium 32 in which a dye is dissolved, and a pair of electrodes 33, 34 mutually opposed across the dispersion medium. Between the individual elements, there is formed a spacer/partition 35 for maintaining a constant distance between the upper and lower substrates 36 and for preventing the displacement of the electrophoretic particles between the elements. The element is driven by applying a voltage to the electrophoretic dispersion medium 32 through the electrodes 33, 34, thereby attracting the electrophoretic particles 31 to the electrode having a polarity opposite to that of charges of the electrophoretic particles 31. A display is achieved by the color of the electrophoretic particles 31 and the color of the electrophoretic dispersion medium 32 in which a dye of a color, different from that of the electrophoretic particles, is dissolved. FIG. 3 shows two display states.

Certain proposals have been made on the electrophoretic particles. For example, Japanese Patent Application publication No. H02-141730 discloses a method of employing particles of a metal oxide colloid as the electrophoretic particles. Also it is proposed to reduce the specific gravity of the electrophoretic particles by using a porous material in order to prevent precipitation or separation of the electrophoretic particles and to maintain the dispersion state satisfactory over a prolonged period. Japanese Patent Application Laid-Open No. H02-24633 discloses electrophoretic particles formed by coating porous organic materials with inorganic oxides, while Japanese Patent Application Laid-Open No. 2000-227612 discloses fine hollow particles having a pigment component on the surface.

As to colored particles other than the electrophoretic particles, Japanese Patent Application Laid-Open No. 2000-202280 describes a coloring composition in which dyes are supported on mesoporous silica.

Coloring materials are utilized in various forms, not only in a particle form but also in a film form, for example, a color filter employed in a liquid crystal display.

### DISCLOSURE OF THE INVENTION

Concerning the printing apparatus, several problems are present with the inks. For example, most color inks are based on dyes, but pigments being fine colorant particles are advantageous in consideration of ink blotting, bleeding, weather resistance etc. However, since pigments are inferior to dyes in the clarity of color, there is desired inks based on color particles in which dyes are incorporated into the fine particles while maintaining their color developing properties.

There are also certain problems common between the inks and the electrophoretic particles for the electrophoretic display apparatus. For example, when particles are formed from a porous organic materials and coated with inorganic oxides, there arises incompatible problems that the thick pigment layer on the particles surface increases the specific gravity thereby impairing the dispersibility while the thin pigment layer cannot provide sufficient coloration. Also there are problems that porous particles colored with pigments have problems that color tones are limited because the usable materials are limited, and that the electric charge varies greatly with the color tone since it is necessary to change the pigment to change the color tone. Also porous pigment particles have low mechanical strength, which causes separation of the fine pigment particles from the porous particles forming fine non-porous particles of larger specific gravity, thereby giving detrimental influence on the display performance. For these reasons, there are demands for uniform particles with low specific gravity and excellent coloration.

Regarding the color filter, in order to obtain vivid color, there is desired a method of coupling and stably supporting a large amount of dyes on the surface of a solid material such as glass.

In consideration of such background, particles or films in which dyes are supported by porous materials such as a mesoporous material is expected suitable as ink particles, electrophoretic particles and color filters, but the conventional technology for incorporating dyes on mesoporous silica has a serious drawback that the surface of the particles cannot adsorb many of the anionic dyes, that are industrially used for inks, because of the insufficient positive charge without any surface modification.

The present invention relates to the aforementioned problems, and is to provide colored silica particles and colored films having sufficient coloration to be used as a colorant and is a producing method for such colored silica particles and colored films.

Also the present invention provides an ink constituted to contain the aforementioned colored silica particles, which ink shows a vivid color developing property, little blotting and bleeding, and excellent weather resistance.

Furthermore, the present invention provides electrophoretic particles made of the aforementioned colored silica particles having microscopic structural uniformity, low specific gravity and excellent dispersibility, and an electrophoretic display apparatus utilizing such electrophoretic particles.

Furthermore, the present invention provides a color filter constituted of the aforementioned colored silica films and showing a vivid color developing property, and excellent weather resistance.

More specifically, the present invention provides a colorant characterized in carrying anionic dyes on porous silica having mesopores of a uniform diameter, of which at least a part of the surface is modified with a material having a function of binding anionic substances.

A material having a function of binding anionic substances preferably includes a silane coupling agent having a cationic site, or a compound containing a bond between oxygen and a metal element capable of forming an oxide having an isoelectric point higher than silica.

The present invention also provides a method for producing a colorant comprising the steps of: hydrolyzing and condensing a substance being a silica source in the presence of an amphiphilic substance thereby preparing a precursor of a porous silica which comprises a composite of silica and an organic substance; eliminating the amphiphilic substance from the precursor thereby obtaining a porous silica; modifying at least a part of the pore surface of the porous silica with a material having a function to bind anionic substances; and adsorbing an anionic dye to the porous silica.

### BRIEF DESCRIPTION OF THE DRAWINGS

FIG. 1 is a schematic view showing a first embodiment of the present invention.

FIG. 2 is a schematic view showing the structure of an electrophoretic display apparatus of the present invention.

FIG. 3 is a schematic view showing the structure of a prior electrophoretic display apparatus and an operating principle thereof.

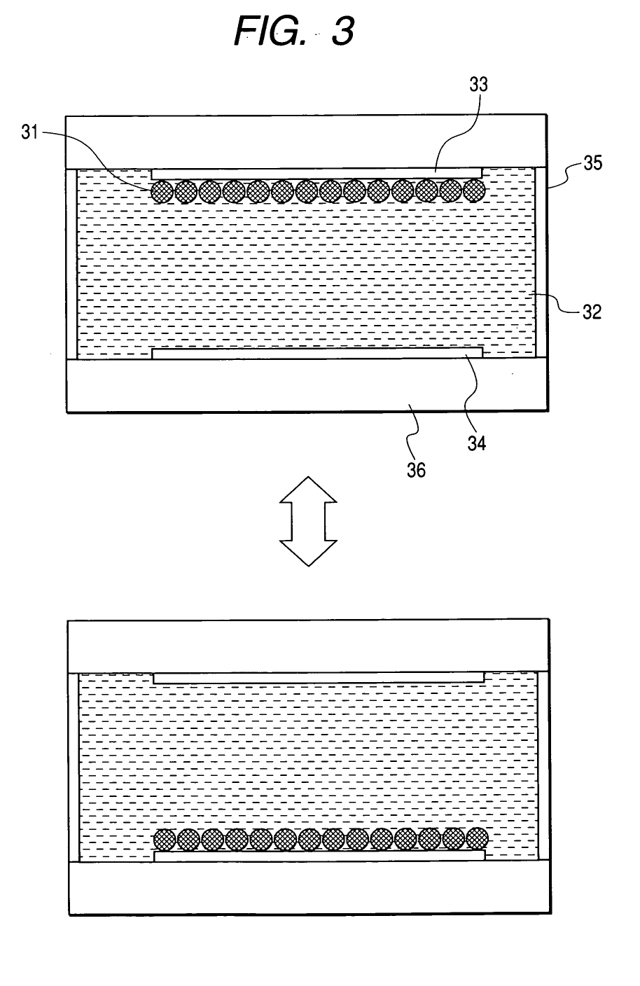

FIG. 4 is a schematic view showing a second embodiment of the present invention.

FIG. 5 illustrates weather resistance of the printed matter and the color filter.

### BEST MODE FOR CARRYING OUT THE INVENTION

The present inventors studied the aforementioned problem that the conventional mesoporous silica cannot adsorb most of the dyes widely used for ink, and noticed that many industrially useful dyes are anionic.

The conventional technology to hold a dye in/on a porous substance such as mesoporous materials cannot achieve sufficient adsorption of anionic dyes on porous silica because of the following reason. Silica has an isoelectric point of about 2, so that the silica surface is negatively charged in a pH range higher than 2 and thus cannot adsorb anions. Even at a pH of about 1, the surface has a relatively small positive charge density, and is unable to secure a sufficient adsorption amount. Also further decrease in pH for increasing the charge density may result in a denaturing of dyes.

The present inventors have found out that an industrially excellent colorant can be obtained by carrying anionic dyes on porous silica in which a material having a function of binding anionic substances is formed on at least a part of the surface of the fine pores, and have thus made the present invention.

In the following the present invention will be explained in more details.

### First Embodiment

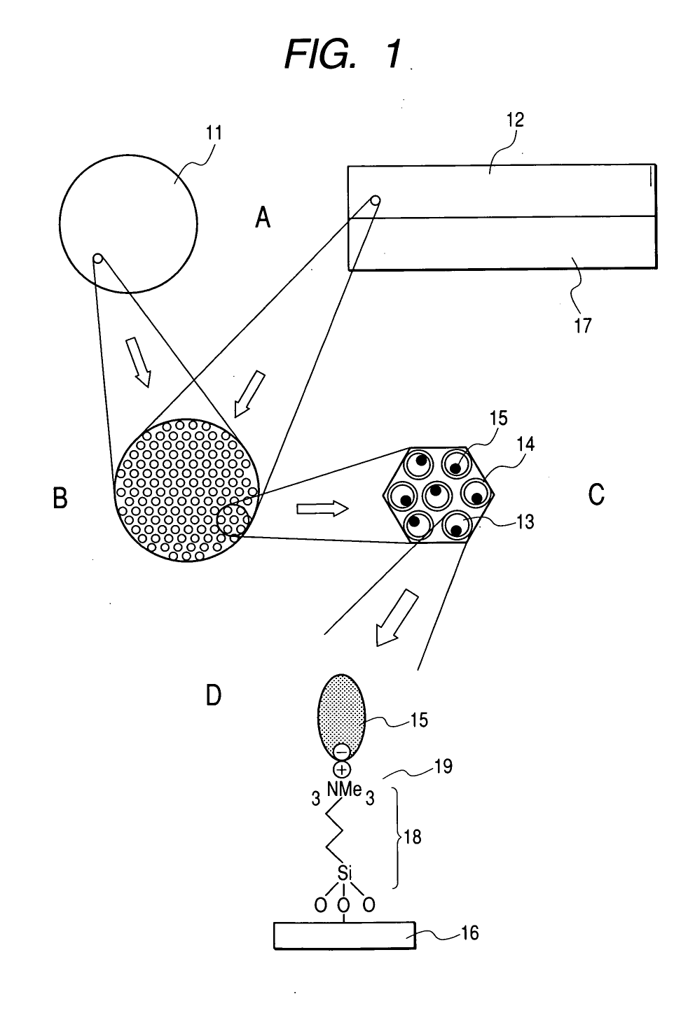

In FIG. 1, a colorant of the first embodiment of the present invention is schematically illustrated (A). The colorant is shaped as a particle or a film according to the purpose. There are shown a colorant particle 11 and a colorant film 12 formed on a substrate 17.

B is a schematic magnified illustration of a part of the particle or the film in A, showing the surface of the particulate colorant or a vertical cross section-of the film-shaped colorant where fine pores of porous silica are uniformly arranged.

C is a further magnified illustration of a part of B, showing that the internal wall of the uniform mesopores 13 is covered with a material 14 having a function of binding anionic substances, and carrying an anionic dye 15 thereon. D is a further magnified schematic illustration, in which a silanol group present on the surface of the pore wall 16 of the porous silica and a molecule 18 of a silane coupling agent are coupled to constitute the material 14 having a function of binding anionic substances. An ammonium group 19 constituting a cationic site of the molecule 18 of the silane coupling agent binds the anionic dye 15.

First, a producing method for the porous silica to be employed in the present invention is explained.

The porous silica advantageously employed in the present invention is so-called mesoporous silica formed using assemblies of surfactants as a template. The mesopore is named according to the IUPAC classification, and means pores with a diameter of 2 to 50 nm. For microporous substances having a smaller pore diameter, the limited dyes with a small size can be incorporated in the pores. In macroporous substances having a larger pore diameter, dye molecules may cause aggregation in the pore, thus resulting in deterioration of the color.

However, any method that can prepare mesoporous silica with uniform fine pores, other than the method of utilizing assemblies of surfactant molecules as a template, can also be applied to the preparation of the colorant of the present invention.

In the following, a method for preparing mesoporous silica particles is explained. The mesoporous silica particles can be prepared with an aqueous solution containing a surfactant and a precursor of silica. The mesoporous silica can be prepared by various methods, using an alkaline aqueous solution as described in Nature, 359, pp. 710-712, or an acidic aqueous solution as described in Nature, 368, pp. 317-321. In particular, spherical particles with a uniform particle size, that are suitable for the use in the present invention, can be obtained when the reaction is incorporated out with an addition of an alcohol to the solution and employing a silicon alkoxide as a silica source.

Mesoporous silica particles with hollow pores can be obtained by removing the surfactant from the pores of thus prepared particles of the mesostructured silica. However, the producing method for the porous silica particles to be employed in the present invention is not limited to the aforementioned method. Also the shape of the mesoporous silica particles is not limited to spherical but can also be gyroid, disc, hexagonal or the like.

Also the size of the individual particles is not particularly restricted,.but is preferably 1 μm or less for the particles for inks, is more preferably 500 nm or less. In an application to inks for ink jet printing, a large particle size may cause clogging in an ink flow path or in a ink jet nozzle. Also for electrophoretic particles, a particle size is preferably within a range of 50 nm to 100 μm, more preferably 200 nm to 10 μm. Particles with an excessively large particle size become difficult to be moved by the electrostatic force, thereby deteriorating the display performance. The size of the prepared particles can be controlled by varying conditions of the preparation, such as the rate of hydrolysis and the concentration of the silica source material. For example, the present inventors have elucidated that the conditions such as the use of a silica source with a high hydrolysis rate, higher reaction temperature, and higher concentration of a hydrolysis catalyst reduce the size of the formed particles.

In the following, a method for preparing a mesoporous silica film is explained. The methods for the preparation of a mesoporous silica film is categorized into two: one is so-called the solvent evaporation method based on sol-gel chemistry, and the other is a method of precipitating a mesostructured silica on a substrate, through heterogeneous nucleation and growth of mesostructured silica seeds on the substrate. In the present invention, a mesoporous silica film prepared by either method can be satisfactorily employed.

First, there will be explained the solvent evaporation method. In the solvent evaporation method, the mesostructured silica can be obtained by coating, for example by spin coating or dip coating of a substrate with a precursor solution containing a surfactant, a silica source, and an acid that acts as a hydrolysis catalyst. The thickness of the film can be arbitrarily controlled by controlling the coating conditions. Any substrate capable of withstanding the preparation process may be employed, preferably that of glass, plastics or ceramics. Regarding a color filter preparation, a transparent substrate is employed. This method has an advantage that the preparing method is simple.

Next, a method based on heterogenoeous nucleation and nuclear growth of mesostructured silica seeds on a substrate is explained. In this method, a mesostructured silica film is formed on a substrate by maintaining the substrate in a reaction solution containing a surfactant, a silica source and an acid that acts as a hydrolysis catalyst. The film thickness can be controlled by the reaction time and the concentration of the reaction solution. In this method, optimum substrates have to be selected to provide a transparent continuous film. As an example, there can be employed a glass substrate coated with a polymer compound. This method has an advantage that the formed film generally has a high structural regularity.

A mesoporous silica film with hollow pores can be obtained by removing the surfactant from the pores of thus prepared mesostructured silica film.

The surfactant employable in the producing method for the mesoporous silica particles or films is not particularly restricted and any surfactants, capable of eventually providing the desired mesoporous material, can be employed. Examples include cationic surfactants such as quaternary alkyl ammonium salts, nonionic surfactants containing polyethylene oxide as a hydrophilic group, nonionic block copolymer surfactants. The optimum surfactant is selected according to the desired porous structure and pore diameter. Also an additive such as mesitylene may be added to increase the size of the micelles.

Various silica sources can be employed. For example, alkoxides such as tetramethoxysilane, tetraethoxysilane, tetrapropoxysilane, silicon chlorides are preferably used.

Several methods are available to remove the surfactant from the mesostructured silica, e.g., calcination, ultraviolet light irradiation, decomposition by oxidation using ozone, extraction using a supercritical fluid, and extraction using a solvent. In the present invention, any method can be satisfactorily employed as long as it does not rupture the porous structure. In particular, calcining at relatively low temperature of 500° C. or less and extraction with a solvent are advantageous for coupling a silane coupling agent to be explained later, since silanol groups on the silica surface such as in the pores will remain in a relatively large amount.

In mesoporous silica, the pores are known to assume various structures such as a two-dimensional hexagonal structure, a three-dimensional hexagonal structure, or a cubic structure. FIG. 1 illustrates a case of the two-dimensional hexagonal structure, but the mesoporous silica with any porous structure can be satisfactorily employed in the present invention. Also pores with a uniform diameter but a random arrangement can also be employed.

For evaluating the pore size distribution in the porous silica, usually employed is a method of measuring adsorption isotherms of a gas such as nitrogen. The pore size distribution can be calculated from the obtained isotherm, for example by the Berret-Joyner-Halenda (BJH) analytical method. The pore size distribution of the mesoporous silica used in the present invention, calculated from the obtained adsorption isotherm using the BJH method, has a single maximum value, and that 60% of the pores, preferably 80% of the pores, are included in a range of the width of 10 nm or less in the pore size distribution. A range of the width of 10 nm means a range where the difference between the maximum value and the minimum value is 10 nm, such as a range from 2 to 12 nm. Mesoporous silica of a pore size distribution exceeding such a range may result in problems such as unevenness in the dye adsorption amount, low optical density of the particles and variation in the specific gravity between the particles, thus deteriorating the display performances.

In the first embodiment of the invention, the internal wall of the pores of the mesoporous silica particles or the mesoporous silica films prepared as described above is modified with a silane coupling agent having a cationic site. The silane coupling agent having a cationic site with an anion exchangable property can easily and firmly bind anionic dyes.

As the silane coupling agent having the cationic site, a silane coupling agent containing an ammonium group, i.e., positively charged nitrogen, can be advantageously employed. An anionic dye binds to such a positively charged group in the pores. The present inventors are considering that when a silane coupling agent with an ammoniumsalt such as N-trimethoxysilylpropyl-N,N,N-trimethylammonium chloride (hereinafter represented as TPTCA) is used, a chloride ion or a hydroxide ion is exchanged with a dye anion. Preferred examples of the usable silane coupling agent includes, in addition to TPTCA, an ammonium chlorides such as N-trimethoxysilylpropyl-N,N,N-tri-n-butyl ammonium chloride, octadecylmethyl(3-trimethoxysilyl)propyl ammonium chloride. 3-aminopropyl trimethoxysilane, 3-aminopropyl triethoxysilane, N-2(aminoethyl)-3-aminopropylmethyl dimethoxysilane and N-phenyl-3-aminopropyl trimethoxysilane can also be employed. The present inventors consider that, in these cases, nitrogen is quaternalized by a reaction with water, and a hydroxyl group is exchanged with a dye anion.

The surface modification with the silane coupling agents can be easily achieved by immersing the mesoporous silica particles or the mesoporous silica films in an ethanol solution of a silane coupling agent. If necessary, the excess amount of the silane coupling agent on the external surface may be eliminated by rinsing.

An anionic dye is bound to thus prepared electrophoretic particles or films, having an anion exchangable property on the surface of the pores. Such dye is not particularly restricted, and any anionic dyes having a size smaller than the mesopores can be substantially used. For example, dyes such as azo dyes, anthraquinone dyes, phthalocyanine dyes, indigoid dyes, carbonium dyes, quinonimine dyes, and methine dyes can be employed. Particularly the present embodiment is very effective for azo dyes or phthalocyanine dyes. Specific examples of the anionic dye include direct blue which is one of the phthalocyanine dyes, acid yellow and acid red which are representatives of azo dyes.

When the porous silica is particles, a commonly used simple method for binding dyes is that the surface treated porous silica particles are dispersed in an aqueous solution of the dye followed by separation and rinsing. However, there can also be employed any other method that can introduce dyes into the pores without destructing the structure. The particles may be dispersed in an aqueous dye solution by ultrasonic treatment or the like according to necessity.

Also when the porous silica is a film, the surface treated porous silica film is immersed in an aqueous solution of dyes and leave therein.

The amount of the anionic dye introduced into the pores is determined by the density of the silane coupling agent present on the surface of the pores. The amount of the silane coupling agent can be controlled by the density of the silanol groups on the silica surface. In order to increase the incorporated amount, the surfactant should be removed by low-temperature calcination or by extraction with a solvent.

Since the pore size of mesoporous silica is sufficiently larger than the size of most dye molecules, the adsorption amount of the dyes becomes almost the same, provided that given conditions such as the surfactant removal conditions, the silane coupling agent to be employed, the dye concentration in the solution, the charge per dye molecule and the like are the same. Therefore, the particles after the dye coupling have a substantially constant surface charge density regardless of the dye species employed. Thus when the colorant particles of the present embodiment are employed as electrophoretic particles, the driving characteristics of the particles do not vary significantly when the dye species is changed, whereby the display of different colors can be executed under substantially the same driving conditions.

As explained above, the amount of adsorbed dyes is determined by the amount of silanol groups on the particle surface. Based on the density of the silanol groups in the mesoporous silica, the present inventors are considering that the dyes are not adsorbed in aggregated states in the pores but they are adsorbed in a substantially monomeric state as schematically shown in FIG. 1. The adsorption amount of dyes is preferably within a range of 5 to 30 wt % with respect to the weight of the porous silica, but such a range is not restrictive. Since the dyes are adsorbed in the pores, aggregation of the dye molecules is prevented thereby enabling clear and strong coloring, which is one of the most important features of the colorant of the present embodiment.

In case the colorant particles of the present embodiment are employed as electrophoretic particles, a specific gravity thereof becomes important. According to the investigation of the present inventors, the colored silica particles can have a specific gravity within a range from 0.6 to 2.0, preferably 0.6 to 1.5, and more preferably 0.7 to 1.2. The specific gravity can be measured by a known method, for example a simple method of dispersing the particles in a solution of known specific gravity and judging the-specific gravity from the level of sedimentation. Also for obtaining uniform particles, a classifying operation may be executed on the prepared particles.

Also a surface coating (not shown in FIG. 1) may be applied to the individual colored silica particles, for the purposes of avoiding aggregation of the colored silica particles and of regulating the specific gravity. Examples of the coating method include spray coating, in-situ polymerization, sputtering and plating.

When the colored silica particles is employed as a component of inks, they are strongly bound by the paper fibers and less diffusible between the paper fibers compared with the dye alone, providing advantages of less blotting, less line broadening and less bleeding. Also since the dyes are mainly bound in the interior of the pores of mesoporous silica, the dyes are less influenced by external factors such as light or chemical substance. Thus one of the remarkable effects is improved weather resistance.

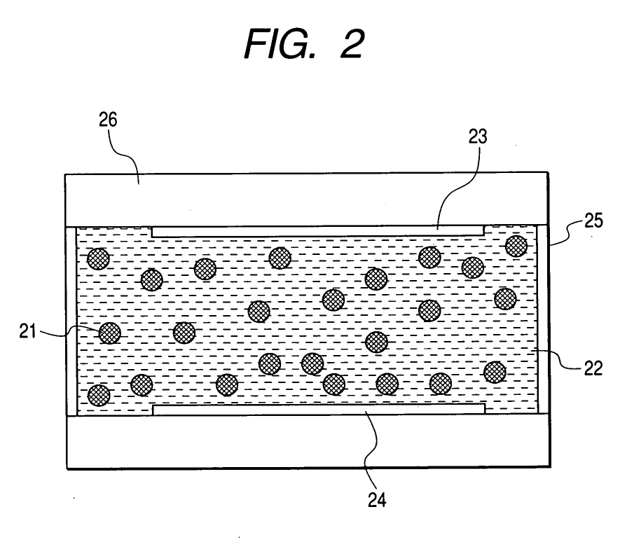

FIG. 2 schematically illustrates an example of an electrophoretic apparatus utilizing the colorant particles of the present embodiment as the electrophoretic particles. The known electrophoretic apparatus can be applied and is not particularly restricted. At least it includes electrophoretic particles 21 of the present embodiment, a dispersion medium 22 in which such electrophoretic particles are dispersed, and substrate 26 which bears an electrode 23 or 24. Under the application of an electric field, the particles migrate toward the upper or lower electrode, thereby providing a display with the color of the particles or of the dispersion medium. In the electrophoretic particles of the present embodiment, the dye molecules are supported in the pores by electrostatic bonding, and do not diffuse into the dispersion medium.

Also a multi-color display can be prepared by using particles prepared with dyes of different colors. If the particles have different specific gravities due to the dyes used in such a case, it can be coped with by adjusting the specific gravity of the dispersion medium.

In case the colored silica film is used in a color filter, in addition to the aforementioned method of immersing in a dye solution, a color filter of a desired pattern can be obtained by subjecting a mesoporous silica film of which interior of the pores has been modified with the silane coupling agent to a patterning using an ink jet method with dyes of different colors.

The thickness of the mesoporous silica film to be employed in the color filter is optimized in consideration of the dye amount and the transmittance.

A surface coating, not shown in FIG. 1, may be applied to the film surface for the purpose of preventing damage on the film and reducing reflectance. Coating methods for the particles are applicable. Thus, the present embodiment provides a coloring material with excellent color development, by modifying the surface of mesoporous silica with a cationic silane coupling agent, which enables the mesoporous silica to carry an anionic dye in an amount not achievable with not-modified silica.

### Second Embodiment

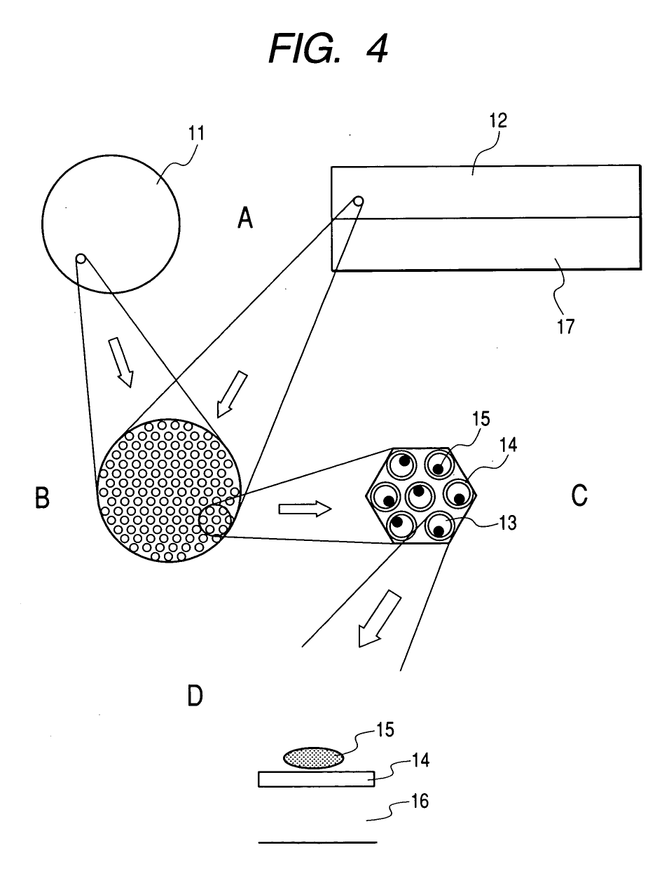

In FIG. 4, a colorant of a second embodiment of the present invention is schematically illustrated in A. The colorant is shaped as a particle or a film according to the purpose. The components the same as in FIG. 1 are represented by the same numerals.

B is a schematic magnified illustration of a part of the particle or the film shown in A, and shows a surface of a particulate colorant or a vertical cross section of a film-shaped colorant, indicating that fine pores of porous silica are uniformly arranged.

C is a further magnified illustration of a part of B, showing that internal wall of the uniform pores 13 is covered with a material 14 having a function of binding anionic substances, and carrying an anionic dye 15 thereon.

D is a further magnified schematic illustration, and, on at least a part of the surface of the pore wall 16 of the porous silica, a material 14 having a function of binding anionic substances is provided, where the material 14 is comprised of a oxide compound containing a metal element and oxygen that has a higher isoelectric point than silica. An anionic dye 15 is incorporated on its surface.

The same producing method for the porous silica of the first embodiment can be applied for this embodiment.

In the colorant of the second embodiment of the invention, an oxide layer of which isoelectric point is higher than that of silica is formed on the surface of the pores. The oxide with a higher isoelectric point than that of silica can be, for example, aluminum oxide, zirconium oxide or magnesium oxide, and any white oxide can be basically applied to the electrophoretic particles of the present embodiment. Zirconium oxide can adsorb a dye in a large amount, and provides a particularly preferable result. In addition to oxide formation, it is possible to obtain a similar effect. For instance, mesoporous silica, in which the surfactant has been removed, can be treated with an aqueous solution of zirconium oxynitrate to obtain the same effect as the formation of zirconium oxide. According to the study by the present inventors, the similar effect can be obtained by forming a layer 14 of a compound including oxygen and a metal element which can form an oxide with an isoelectric point higher than that of silica.

An oxide having an isoelectric point lower than 2 (the isoelectric point of silica) adsorbs the anionic dye insufficiently, thus being unable to provide a sufficient color. The isoelectric point of oxides is described, for example, in Langmuir, 13, p. 6315. More specifically, isoelectric point means a pH value at which the surface charge of an oxide becomes zero in an aqueous solution and is also called PPZC (pristine point of zero charge). The isoelectric point is measured for example by a potentiometric titration. The isoelectric point of oxide is, for example, about 8 with zirconium oxide, about 9 with aluminum oxide and about 12 with magnesium oxide.

The anionic dye 15 is adsorbed on thus prepared mesoporous silica, bearing an oxide of which isoelectric point is higher than that of silica on the surface. The dye is not particularly restricted, and any anionic dye with a size smaller than that of the mesopores is substantially usable.

Specific examples of the anionic dyes include direct blue and acid yellow.

In case of particles, dye-adsorption can be incorporated out by a simple method of dispersing the surface-treated porous silica particles in an aqueous solution of the dye and then separating and rinsing the particles, but any other methods can be employed as long as it can introduce the dye into the pores without destructing the structure.

In case of a film, introduction of dyes can be achieved by immersing the substrate bearing the film in an aqueous solution of the dye, and subsequent rinsing of the film. It is also possible to pattern the mesoporous silica film with the dye in a desired form by a printing process or by an ink jet process.

The amount of the anionic dye incorporated into the pores is determined by the charge density of the oxide. It is therefore possible to control the adsorption amount of the dye also by controlling the surface charge of the inorganic substance, namely by controlling the pH of the aqueous solution of the dye.

Since the pore size of the mesoporous silica employed in the present embodiment is sufficiently larger than the size of most dye molecules, the adsorption amount of the dye becomes almost the same under the same conditions, e.g., pH of the dye solution during adsorption, dye concentration, charge amount per dye molecule. Therefore, the mesoporous materials after the dye adsorption has substantially constant surface charge density regardless of the kind of dyes. Consequently, in case the colorant particles of the present embodiment are employed as electrophoretic particles, the driving performance of the particles do not vary significantly when different dyes are used, whereby display with different colors can be achieved under substantially the same driving conditions.

As explained above, the amount of adsorbed dye is determined by the charge density on the surface of the mesoporous materials, and the present inventors are considring that the dyes are not adsorbed in aggregated states in the pores but they are adsorbed in a substantially monomeric state as schematically shown in FIG. 1. Such a state suppresses interaction of the dye molecules, thereby providing vivid color. The adsorption amount of the dyes is preferably within a range of 5 to 30 wt % with respect to the weight of the porous silica, but such range is not restrictive.

(Applications)

When the colorant particles of the present embodiment are employed as electrophoretic particles, it is important to control the specific gravity of the particles as well as the size of the particles. The specific gravity of the electrophoretic particles is within a range from 0.6 to 2.0, preferably 0.6 to 1.5, and more preferably 0.7 to 1.2. The specific gravity can be measured by a known method, for example, a simple method of dispersing the particles in a solution of a known specific gravity and judging the specific gravity from a degree of sedimentation. Also for obtaining uniform particles, a classifying operation may be executed on the prepared particles. The specific gravity of the particles is regulated at an optimum value by controlling the pore structure, pore wall thickness, and the adsorption amount of the dye and the like.

Also in an application to the electrophoretic particles, a surface coating, not shown in FIG. 1, may be applied to the individual colored silica particle, for the purposes of avoiding agglomeration of the colored silica particles and of regulating the specific gravity. Examples of the coating method include spray coating, in-situ polymerization, sputtering and plating.

When the colored silica particles of the invention is employed in ink, regulation of the specific gravity and control of the relating dispersion state are often required. These parameters are controlled at optimum values by methods similar to those in the aforementioned electrophoretic particles.

When the colored silica particles is employed as a component of ink, they are strongly bound by the paper fibers and less diffusible between the paper fibers compared with a dye alone, providing advantages of less blotting, less line broadening and less bleeding. Also since the dye is mainly bound in the interior of the pores of mesoporous silica, the dye is less influenced by external factors such as light or chemical substance. Thus one of the remarkable effects is improved weather resistance.

When the film shaped coloring material of the present invention is applied to a color filter, a great advantage is vivid color development as with the case of ink and electrophoretic particles. Other advantages are that the amount of the adsorbed dye can be increased since the dye is adsorbed onto the internal surface of the porous material having a large specific surface area, and that weather resistance is excellent since the dye is adsorbed in fine pores. In an application to a color filter, the film thickness of the mesoporous silica film, the incorporated dye amount, the area carrying the dye and the like are optimized in consideration of the desired optical characteristics. Surface coating, not shown in FIG. 1, may be applied to the film surface for the purpose of preventing damages on the film surface and reducing the reflectance. Coating methods applicable to the particles can also be employed.

For producing a color filter of the present invention, in addition to the aforementioned method of immersing in a dye solution, a color filter of a desired pattern can be obtained by subjecting a mesoporous silica film of which interior of the pores has been modified with the silane coupling agent to patterning using an ink jet method and dyes of different colors.

FIG. 2 schematically illustrates an example of an electrophoretic apparatus utilizing the colorant particles of the present embodiment as electrophoretic particles. The electrophoretic apparatus can be a known apparatus and is not particularly restricted. It can at least include electrophoretic particles 21 of the present embodiment, a dispersion medium 22 in which such electrophoretic particles are dispersed, and substrate 26 which bears an electrode 23 or 24. 25 indicates a partition. Under the application of an electric field, the particles migrate toward the upper or lower electrode, thereby providing a display with the color of the particles or of the dispersion medium. Also when a display apparatus for plural color display is desired, it can be realized by employing particles prepared with dyes of different colors. If the particles have different specific gravities due to the dyes used, it can be coped with by adjusting the specific gravity of the dispersion medium.

Thus, according to the present invention, by providing at least a part of the surface of the pores with a material having a function of binding an anionic substance, such as a silane coupling agent having a cationic site and showing an anion exchange ability, or a compound having a binding of oxygen and a metal that can form an oxide having a higher isoelectric point than silica, an anionic dye can be incorporated in the pores, thereby providing a satisfactory colorant excellent in color development and weather resistance, applicable to an ink, electrophoretic particles and a color filter.

### EXAMPLES

In the following, the present invention will be clarified further by examples, but the present invention is not limited to such examples.

### Example 1

In this Example, a blue anionic dye was adsorbed on the mesoporous silica particles with an average diameter of about 180 nm, and the particles were applied to an ink for an ink jet printer. The pores of the mesoporous silica particles had been modified with TPTCA to prepare the particles of blue coloring material,

[Preparation of Mesoporous Silica Particles]

0.25 g of n-hexadecyltrimethyl ammonium bromide (manufactured by Kishida Kagaku Co.), which is a cationic surfactant, were dissolved in 78.2 ml of pure water, to this solution 25.3 ml of a 30% ammonia aqueous solution and 120 ml of ethanol were added to obtain an alkaline solution of the surfactant in an ethanol-water mixture. The pH of the surfactant solution was 12.2. The surfactant solution was heated to 70° C., to which 0.35 ml of tetramethoxysilane were added. The mixture was stirred for about 2 hours at 70° C., then transferred into a pressure-resistant container having a fluorinated resin interior, and sealed for about one day at 90° C. to obtain a precipitate. The precipitate was sufficiently rinsed with pure water and dried. The obtained powder was calcined for 5 hours in an air atmosphere at 500° C. to remove the surfactant.

From the X-ray diffraction, the powder was confirmed as mesoporous silica having a two-dimensional porous hexagonal structure, with a (100) lattice distance of 3.8 nm.

From the measured nitrogen gas adsorption isotherm, the specific surface area of the powder was estimated to be 836 m²/g. The pore size distribution calculated by the BJH method showed a distribution with a sharp single maximum at 2.2 nm, and the distribution curve was within a range from 2 to 5 nm. From these data, it was confirmed that the prepared mesoporous silica havea substantially uniform pore size. Also observation with an FE-SEM (field emission scanning electron microscope) confirmed that the particles were spherical with a substantially uniform size. Also the measurement of the particle size of the 20 particles in the FE-SEM images provided an evidence of the substantially uniform particle size. The estimated average particle size was 180 nm, with a minimum size of 140 nm and a maximum size of 200 nm. Further, the infrared absorption spectrum confirmed that the organic component does not remain in the powder after calcination.

[Modification of the Pore Surface of the Mesoporous Silica Particles]

The mesoporous silica particles were dispersed in a 50% methanol solution of TPTCA (manufactured by Chisso Co.), for 10 hours at room temperature, then separated and sufficiently rinsed with ethanol. The rinsed particles were separated and dried at room temperature. Infrared absorption analysis of these particles showed the absorption peaks assigned as ammonium group and methylene group, thus confirming that TPTCA was coupled to the silica surface. The X-ray diffraction profile of the processed powder showed diffraction peaks at the same positions as in the powder immediately after calcination, thereby confirming that the porous structure was retained. From the nitrogen gas adsorption isotherm of the processed powder, the specific surface area was estimated to be 809 m²/g, and the pore size distribution calculated by the BJH method indicated that the proportion of the pores with smaller sizes increased slightly compared with that before the processing with TPTCA.

[Preparation of a Blue Ink Containing the Mesoporous Silica Particles]

Then an anionic dye was adsorbed on the mesoporous silica particles. 100 mg of the processed mesoporous silica particles were dispersed in 5 ml of a 0.5 wt % aqueous solution of an anionic phthalocyanine dye, Direct Blue 199, by ultrasonication, and the dispersion was left for 1 hour to introduce the dye into the pores. Then the particles containing the introduced dye were rinsed to wash off the excess dye adsorbing on the outer surface. The rinsing was conducted by dispersing the dye-containing powder in ethanol followed by the separation of the powders by centrifuging. This process was repeated twice to completely remove the excess dye adsorbed on the outer surface. The rinsed particles were dried at room temperature to obtain mesoporous silica colorant particles of clear blue color. CHN elemental analysis confirmed that the amount of the dye adsorbed was 21% of the weight of the powder, confirming a large amount of adsorption.

X-ray diffraction profile of the particles after the incorporation of the dye showed diffraction peaks in the same positions as the powder immediately after calcination, thereby confirming that the porous structure is retained. From the nitrogen gas adsorption isotherm recorded for the powder sample after the dye incorporation, the specific surface area was estimated to be 785 m²/g, which was smaller than that before the dye incorporation. The pore size distribution calculated from the isotherm by the BJH method showed a maximum value at an almost the same pore size as that before the dye incorporation, but the proportion of the small-sized pores increased compared with that before the dye incorporation. These data clearly demonstrate that the dye is incorporated in the interior of the pores.

Then, 100 mg of the dye-incorporated mesoporous silica particles prepared above were dispersed by ultrasonication in 2 ml of a transparent ink base, of which composition is shown in Table 1, to obtain a blue ink.

TABLE 1
Composition of the transparent ink
base used for the preparation of the blue ink

| | |
|---|---|
| Glycerin | 7 wt % |
| Triethylene glycol | 10 wt % |
| Hexylene glycol | 5 wt % |
| Water | 78 wt % |

The mesoporous silica particles in the blue ink did not show precipitation.

[Preparation of a Yellow Ink Containing Mesoporous Silica Particles]

100 mg of the mesoporous silica particles processed with TPTCA, prepared in the aforementioned process, were dispersed in 5 ml of a 0.75 wt % aqueous solution of an anionic azo dye, Acid Yellow 23, and processed in the same manner as with the blue ink, to obtain mesoporous silica particles of vivid yellow color. CHN elemental analysis confirmed that the adsorbed amount of the dye was 21% of the weight of the powder, confirming a large amount of adsorption.

X-ray diffraction profile of the dye-incorporated particles showed diffraction peaks in the same positions as in the powder immediately after calcination, thereby confirming that the pore structure was retained. From the nitrogen gas adsorption isotherm recorded for the powder sample after the dye incorporation, the specific surface area was estimated to be 772 m²/g, which was smaller than that before the dye incorporation. The pore size distribution calculated from the isothermby the BJH method showed a maximum value at an almost the same pore size as that before the dye incorporation, but the proportion of the small-sized pores increased compared with that before the dye incorporation. These data clearly demonstrate that the dye is incorporated in the interior of the pores.

Then, 100 mg of the dye-incorporated mesoporous silica particles prepared above were dispersed by ultrasonication in 2 ml of a transparent ink base, of which composition is shown in Table 2, to obtain a yellow ink.

TABLE 2
Composition of the transparent ink
base used for the preparation of the yellow ink

| | |
|---|---|
| Glycerin | 5 wt % |
| 2-Pyrrolidone | 10 wt % |
| Isopropyl alcohol | 4 wt % |
| Water | 81 wt % |

The mesoporous silica particles in the yellow ink did not show precipitation.

[Printing with the Inks Containing the Dye-Incorporated Mesoporous Silica Particles by an Ink Jet Printer]

Then the blue ink and the yellow ink containing the mesoporous silica particles prepared as described above were filled in a cyan and a yellow cartridge, respectively. Then the cartridges were set in a commercially available ink jet printer (BJ-S630, manufactured by Canon Inc.) connected to a personal computer.

After the head cleaning, printing was made on commercially available copy paper. The printed image was comprised of three portions, characters with the blue ink only, characters with the yellow ink only, and a checkerboard pattern with the blue and the yellow inks, prepared in advance on the personal computer.

The printed image was not perturbed, for example, by nozzle clogging, and printing was satisfactorily incorporated out until the inks were depleted.

[Evaluation of the Print]

First, the portions printed with blue color or yellow color were observed visually. Neither blotting nor line broadening was observed in each portion. Color mixing (bleeding) by ink blotting was not observed at the boundary of blue and yellow colors. When water was dropped onto the paper immediately after the printing, the image was satisfactorily retained without ink blotting.

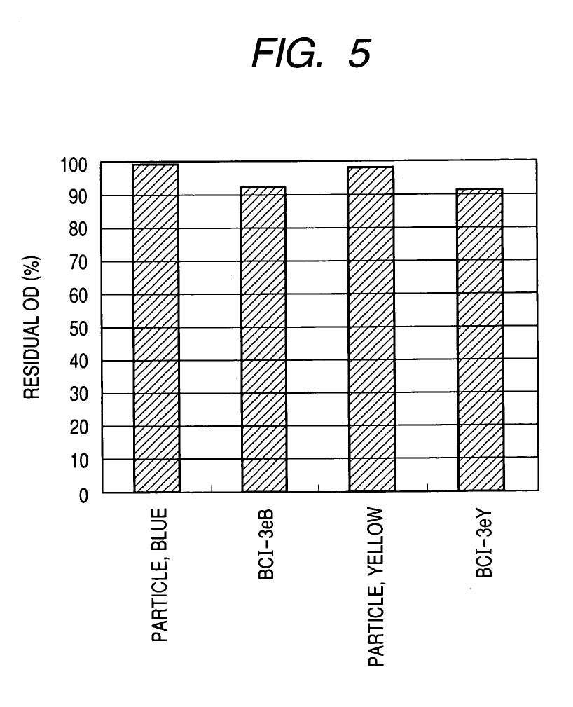

Next, a reference print of the same pattern was prepared using a dye-based cyan ink (trade name BCI-3eC, manufactured by Canon Inc.) and a dye-based yellow ink (trade name BCI-3eY, manufactured by Canon Inc.) using the same BJ-S630 printer, and the same copy paper. This reference print and the aforementioned print were subjected to the irradiation from a xenon lamp for 100 hours to evaluate the weather resistance by measuring a retention rate of the optical density (OD). The results are shown in FIG. 5. It was demonstrated that the blue and the yellow images formed with the inks containing the mesoporous silica particles showed good weather resistance comparable to or better than the reference images formed with the dye-based inks.

Based on these results, it was confirmed that the ink-jet inks employing the colorant particles prepared by modifying the pore surface with TPTCA to incorporate anionic dyes therein, could achieve a satisfactory printing. The obtained print was free from blotting or bleeding, and excellent in both water and weather resistances.

### Comparative Example 1

Mesoporous silica particles were prepared in the same manner as in Example 1. X-ray diffraction and nitrogen gas adsorption measurement confirmed that the mesoporous silica had pores of a two-dimensional hexagonal structure and a specific surface area of 816 m²/g.

Two sets of 100 mg of the mesoporous silica particles were prepared. Then, without treating with the silane coupling agent, they were dispersed under ultrasonication in 2 ml of a 0.5 wt % aqueous solution of Direct Blue 199 and 2 ml of a 0.75 wt % aqueous solution of Acid Yellow 23, respectively, and left for 1 hour for the dye adsorption.

Then, these dispersions were subjected to centrifugation as in Example 1 to remove the supernatant liquid, and the residues were redispersed in ethanol to remove the excess dyes adsorbed on the outer surface. The mesoporous silica particles obtained in the present Comparative Example 1 scarely colored neither by Direct Blue 199 nor Acid Yellow 23, indicating that the dye was scarcely adsorbed in the pores.

### Example 2

This example shows the preparation of an electrophoretic display apparatus utilizing blue silica particles as electrophoretic particles. The blue silica particles were prepared by adsorption of a blue dye on porous silica particles with an average diameter of about 780 nm of which the surface of the pores have been modified with TPTCA.

[Preparation of Mesoporous Silica Particles]

0.25 g of n-hexadecyltrimethyl ammonium bromide (manufactured by Kishida Kagaku Co.), which is a cationic surfactant, were dissolved in 90.0 ml of pure water, to this solution 6.33 ml of a 30% ammonia aqueous solution and 120 ml of ethanol were added to obtain an alkaline solution of the surfactant in an ethanol-water mixture. The pH of the surfactant solution was 9.4. To this surfactant solution was added 0.656 ml of tetrapropoxysilane at room temperature. Then the solution was stirred for about 2 hours, and centrifuged to obtain a precipitate. The precipitate was sufficiently rinsed with pure water and dried to obtain a powder sample. The powder was dispersed in ethanol and refluxed at 70° C. for 24 hours twice to remove the surfactant.

From the X-ray diffraction, the powder was confirmed as mesoporous silica having a two-dimensional hexagonal porous structure, with a (100) lattice distance of 3.3 nm.

From the measured nitrogen gas adsorption isotherm, the specific surface area of this powder sample was estimated to be 1192 m²/g. The pore size distribution calculated by the BJH method showed a distribution with a sharp single maximum at 2.0 nm, and the distribution curve was within a range from 2 to 5 nm. From these data, it was confirmed that the prepared mesoporous silica have a substantially uniform pore size. Also observation with an FE-SEM confirmed that the particles were spherical with a substantially uniform size. Also the measurement of the particle size of the 20 particles in the FE-SEM images provided an evidence of the substantially uniform particle size. The estimated average particle size was 780 nm, with a minimum size of 750 nm and a maximum size of 800 nm. Further, CHN elemental analysis on the powders before and after the refluxing in ethanol confirmed that the organic component in the powder before the reflux treatment was removed by 96 % or more by the refluxing.

[Modification of the Pore Surface of the Mesoporous Silica Particles]

The mesoporous silica particles were dispersed in a 50 wt % methanol solution of TPTCA (manufactured by Chisso Co.), for 10 hours at room temperature, then separated and sufficiently rinsed with ethanol. The rinsed particles were separated and dried at room temperature. Infrared absorption analysis of these particles showed the absorption peaks assigned as ammonium group and methylene group, thus confirming that TPTCA was coupled to the silica surface. The X-ray diffraction profile of the processed powder showed diffraction peaks at the same positions as in the powder before the processing, thereby confirming that the porous structure was retained. From the nitrogen gas adsorption isotherm of this processed powder, the specific surface area was estimated to be 1025 m²/g, and the pore size distribution calculated by the BJH method indicated that the proportion of the pores with small sizesincreased slightly compared with that before the TPTCA treatment.

[Preparation of Colored Mesoporous Silica Electrophoretic Particles]

Then an anionic dye was adsorbed onto the mesoporous silica particles. 100 mg of the processed mesoporous silica particles described above were dispersed by ultrasonication in 5 ml of a 0.5 wt % aqueous solution of an anionic phthalocyanine dye, Direct Blue 199, and were left for 1 hour to introduce the dye into the pores. Then the particles containing the introduced dye were rinsed in the same procedure as in Example 1 to wash off the excess dye adsorbing on the outer surface. This operation removed the excess dye almost completely.

The rinsed particles were dried at room temperature to obtain mesoporous silica colorant particles of vivid blue color. CHN elemental analysis confirmed that the amount of the dye adsorbed by the powder was 21% of the weight of the powder, confirming a large amount of adsorption.

X-ray diffraction profile of the particles after the incorporation of the dye showed diffraction peaks at the same positions as the powder after calcination, thereby confirming that the porous structure is retained. From the nitrogen gas adsorption isotherm recorded for the powder sample after the dye incorporation, the specific surface area was estimated to be 977 m²/g, which was smaller than that before the dye incorporation. The pore size distribution calculated by the BJH method showed a maximum value at an almost the same pore size as that before the dye incorporation, but the proportion of the small-sized pores increased compared with that before the dye adsorption. This clearly indicated that the dye is incorporated in the interior of the pores.

[Confirmation of Electrophoresis]

Electrophoretic property of the dye-incorporated mesoporous silica particles prepared through the foregoing process was evaluated with an electrophoretic apparatus as shown in FIG. 2. Isoparaffin (trade name: Isopar, manufactured by Exxon Inc.) was employed as the insulating liquid (dispersion medium 22). In isoparaffin, succinimide (trade name: OLOA1200, manufactured by Chevron Inc.) was added as a charge controlling agent.

The colored mesoporous silica particles prepared in this example showed satisfactory dispersibility to the aforementioned insulating liquid when dispersed for 10 seconds with ultrasonication. When the dispersion was left to stand, sedimentation of the particles did not occur. Thus, a satisfactory particles dispersion was obtained. The electrophoretic particles containing the colorant prepared in this example moved satisfactorily between the electrodes under an electric field applied thereto, showing satisfactory display performance. It was also confirmed that no aggregation of the particles occurred in the driving operation, and satisfactory driving performance was maintained over a prolonged period.

Based on these results, it was confirmed that the electrophoretic apparatus employing the colorant particles of this invention as electrophoretic particles showed excellent display performance for a long time, where the colorant particles were prepared by adsorption of an anionic dye to mesoporous silica particles of which pore surface had been modified with TPTCA.

### Comparative Example 2

Mesoporous silica particles were prepared in the same manner as in Example 2.

X-ray diffractometry and nitrogen gas adsorption measurement confirmed that the mesoporous silica had pores of a two-dimensional hexagonal structure and a specific surface area of 1170 m²/g.

100 mg of the mesoporous silica particles, without the processing with the silane coupling agent, were dispersed in 2 ml of a 0.5 wt % aqueous solution of Direct Blue 199 with ultrasonication, and were left to stand for 1 hour for dye adsorption.

Then, the dispersion was subjected to centrifugation, as in Example 2, to remove the supernatant liquid and then dispersed in ethanol to remove the excess dye adsorbing on the outer surface. The mesoporous silica particles obtained in this Comparative Example 2 showed scarce coloration, indicating that the dye was scarcely adsorbed in the pores.

### Example 3

In this example, a color filter was prepared where a mesoporous silica film of an average thickness of about 1.0 μm was formed on an alkali-free glass substrate, then the internal wall of the pores of the silica film was modified with TPTCA, and a dye was adsorbed thereon.

[Preparation of Substrate]

A quartz glass substrate of a dimension of 25×20 mm and a thickness of 1.0 mm was rinsed with acetone, isopropyl alcohol and pure water, and was surface cleaned with an ozone asher.

[Preparation of Mesoporous Silica Film]

0.828 ml of ethanol were mixed with 124 ml of 1N hydrochloric acid, and, after addition of 1.0 ml of tetraethoxysilane, the mixture was agitated for 20 minutes at 50° C. After the solution was cooled, there was added an aqueous surfactant solution, formed by dissolving 0.218. g of a nonionic surfactant, polyoxyethylene-10-cetyl ether (trade name: Briji56, manufactured by Sigma Chemical Inc.), in 0.389 ml of pure water. The obtained solution was agitated for 2 hours to obtain a precursor solution.

The precursor solution was applied on the alkali-free substrate at 3000 rpm and dried to obtain a thin film.

From the X-diffraction, the film was confirmed as a mesostructured silica film having a two-dimensional hexagonal structure, with a (199) lattice distance of 5.2 nm. Also the thickness, measured with a needle contact thickness measuring instrument (trade name: α-step, manufactured by Tencor Ltd.), was substantially uniform, 1.0 μm all over the substantially entire surface.

The substrate was calcined in an air atmosphere for 5 hours at 500° C. to eliminate the surfactant. From the X-diffraction of the film after the baking, it was confirmed that the (100) lattice distance was reduced to 3.5 nm, but the hexagonal pore structure was retained almost completely. Also an infrared absorption analysis etc. confirmed that the organic component did not remain on the substrate after the elimination of the surfactant.

Also, such a film was prepared in plural units and scraped off to obtain a powder sample, and nitrogen gas adsorption isotherm conducted thereon confirmed that the powder sample showed a specific surface area estimated to be 964 m²/g. The pore size distribution calculated by the BJH method showed that the pore size distribution was a distribution with a sharp single maximum at 4.3 nm and the distribution curve was within a range from 3 to 7 nm. These data confirmed that the prepared mesoporous silica film had a substantially uniform pore size.

[Modification of Mesoporous Silica Film]

The mesoporous silica film was immersed in a 50% methanol solution of TPTCA (manufactured by Chisso Co.), left to stand for 1 hour at room temperature, then taken out from the solution, sufficiently rinsed with pure water and dried at room temperature. The infrared absorption analysis on the film after the modification confirmed that the silica surface was modified with TPTCA. Also the X-ray diffractometry of the film showed a diffraction peak in the same position as with the film immediately after the baking and before the processing, thereby confirming that the pore structure was retained.

[Preparation of Purple Color Filter]

Then an anionic dye was adsorbed to the mesoporous silica film. The mesoporous silica film processed as explained above was immersed in 10 ml of a 1.0 wt % aqueous solution of an anionic azo dye, Acid Red 52, and was left to stand for 1 hour for dye adsorption. Then the film was rinsed to wash off the excess dye adsorbing on the outer surface. The rinsing was conducted by repeating twice a process of immersing the dye-carrying substrate in ethanol. In this manner, a mesoporous silica film of dense purple (magenta) color was obtained on the substrate. Such a film was prepared in plural units and scraped off, subjected to CHN elemental analysis, which confirmed that the amount of the dye in the film was 21% of the weight of the film, indicating sufficient carrying.

X-ray diffractometry of the film after the dye incorporation showed a diffraction peak at the same position as in the film immediately after the baking, confirming that the pore structure was retained even after the dye retention.

[Evaluation of Color Filter]

Optical absorbance of the thus prepared dye-retaining mesoporous silica film was measured by using a spectrophotometer (trade name: UV-3100, manufactured by Shimadzu Ltd.) to show an absorbance of about 0.8 at the absorption maximum, indicating that coloration was very strong. Also the weather resistance was examined by irradiating with a xenon lamp for 100 hours. It was thus indicated that the mesoporous silica film having TPTCA-modified pore surface could be formed into a color filter of a dense purple color with a satisfactory weather resistance.

### Comparative Example 3

A quartz glass substrate, same as that employed in Example 3, was immersed in a 50% methanol solution of TPTCA (manufactured by Chisso Co.), left to stand for 1 hour at room temperature, then taken out from the solution, sufficiently rinsed with pure water and dried at room temperature. Thus, a surface of the quartz glass was modified with the silane coupling agent.

The substrate, not bearing the mesoporous silica, was immersed in a dye solution same as in Example 3, in the same manner as in Example 3, to bind the anionic dye to the surface. However, when the substrate taken out from the dye solution was rinsed with pure water, almost no coloration was observed on the substrate.

### Example 4

In this example, blue electrophoretic particles were prepared where porous silica particles were prepared with a nonionic surfactant, and the pore surface of the particles was modified with zirconium oxynitrate, and then a blue dye was adsorbed thereto.

3.3 g of a nonionic surfactant, polyoxyethylene-10-cetyl ether (trade name: Brij56, manufactured by Sigma Chemical Inc.) were dissolved in 128 ml of pure water, and 20 ml of 35% hydrochloric acid were added to obtain an acidic solution of the surfactant. 2.2 ml of tetraethoxysilane were added to the surfactant solution, which was agitated for 3 minutes, then transferred to a pressure-resistant container made of a fluorinated resin. The reaction was incorporated out for 1 week at 80° C. to obtain a precipitate. The precipitate was sufficiently rinsed with pure water and dried to obtain powder, which was calcined in an air atmosphere for 10 hours at 550° C.

From the X-diffraction, the powder was confirmed as mesoporous silica having pores in a two-dimensional hexagonal structure, with a (199) lattice distance of 5.3 nm

As a result of nitrogen gas adsorption isotherm, the powder sample showed a specific surface area estimated to be 811 m²/gas. The pore size distribution calculated by the BJH method showed that the pore size distribution was a distribution with a sharp single maximum at 3.8 nm and that the distribution curve was within a range from 2 to 7 nm. These data confirmed that the prepared mesoporous silica had a substantially uniform pore size. Also IR analysis confirmed that the organic component did not remain in the powder after the baking.

The mesoporous silica was dispersed in a 10 wt % aqueous solution of zirconium oxynitrate, stirred for 3 hours at room temperature, then separated and sufficiently rinsed with ethanol. The rinsed particles were separated and dried at room temperature. Elemental analysis confirmed that the internal surface of the mesoporous silica was uniformly processed with zirconium oxynitrate. Also X-ray diffractometry of the processed powder showed that a diffraction peak was at the same position as in the powder immediately after the calcination and before the processing, confirming that the pore structure was retained. From the nitrogen gas adsorption isotherm of the processed powder, the specific surface area was estimated to be 785 m²/g, and the pore size distribution calculated by the BJH method indicated that the pore size distribution scarcely showed a change compared with that before the processing with zirconium oxynitrate.

Then an anionic dye was adsorbed to the mesoporous silica particles. 100 mg of the processed mesoporous silica particles were dispersed in 30 g of a 0.075 wt % aqueous solution of Direct Blue 199, adjusted to pH 1.0 by adding an appropriate amount of hydrochloric acid, and subjected to dye adsorption with agitation using a magnetic stirrer for 1 hour. Then the particles adsorbing the dye were rinsed to wash off the excess dye adsorbing to the outer surface. The rinsing was conducted repeating a process of centrifuging the particles retaining the dye, eliminating the supernatant liquid, re-dispersing the particles in ethanol and centrifuging the particles to eliminate the supernatant liquid. After five cycle of washing, the dye was hardly released from the particles into the supernatant. The rinsed particles were dried at room temperature to obtain mesoporous silica particles of vivid blue color. CHN elemental analysis confirmed that the adsorbed dye amount was 18% of the weight of the powder, indicating sufficient adsorption.

X-ray diffractometry of the particles after the dye adsorption showed a diffraction peak in the same position as with the powder immediately after the baking, confirming that the pore structure was retained. Also nitrogen gas adsorption measurement on the powder sample after the dye adsorption provided a specific surface area of 674 m^{2/}g, which was smaller than that before the dye adsorption. The pore size distribution calculated by the BJH method showed a maximum value at almost the same pore size as that before the dye incorporation, but the proportion of pores of smaller sizes increased compared with that before the dye incorporation. This clearly indicated that the dye was incorporated in the interior of the pores.

The dye-incorporated mesoporous silica particles prepared through the above-described process were classified, and the particles of a size of 2-3 nm were used as electrophoretic particles.

Electrophoretic property of the mesoporous silica particles prepared through the foregoing process and carrying the dye was evaluated with an electrophoretic apparatus as shown in FIG. 2. The colored mesoporous silica particles prepared in this example showed satisfactory dispersibility to the aforementioned insulating liquid when dispersed for with ultrasonication. When the dispersion was left to stand, sedimentation of the particles did not occur. Thus, a satisfactory particle dispersion was obtained. The electrophoretic particles containing the colorant prepared in this example moved satisfactorily between the electrodes under an electric field applied thereto, showing satisfactory display performance. It was also confirmed that no agglomeration of the particles occurred in the driving operation, and satisfactory driving performance was maintained over a prolonged period.

### Example 5

In this example, yellow electrophoretic particles were prepared where porous silica particles were prepared with a nonionic surfactant, and the pore surface of the particles was modified with zirconium oxynitrate, and then a yellow dye was adsorbed thereto.

Mesoporous silica particles were prepared employing a nonionic surfactant (Brij45), and processed with an aqueous solution of zirconium oxynitrate in the same manner as in Example 4. 100 mg of the thus obtained particles were dispersed in 30 g of a 0.075 wt % aqueous solution of Acid Yellow, adjusted to pH 1.0, and the dye adsorption was incorporated out with agitation using a magnetic stirrer for 1 hour. Then the particles adsorbing the dye were rinsed 5 times with ethanol in the same manner as in Example 1 to obtain final mesoporous silica particles carrying the dye. The dye hardly diffuse into the supernatant liquid of the 5th rinsing. The rinsed particles were dried at room temperature to obtain mesoporous silica particles of vivid yellow color. CHN elemental analysis confirmed that the adsorbed dye amount was 17% of the weight of the powder, indicating sufficient adsorption.

X-ray diffractometry of the particles after the dye adsorption showed, in the same manner as in Example 4, a diffraction peak in the same position as with the powder immediately after the baking, thereby confirming that the pore structure was retained. Also nitrogen gas adsorption measurement of the powder sample after the dye adsorption provided a specific surface area of 682 m²/g, which was smaller than that before the dye adsorption. Also in the mesoporous silica particles with the adsorbed dye prepared in this example, the pore size distribution determined by the BJH method showed a maximum value at almost the same pore size as that before the dye incorporation, but the proportion of pores with small sizes increased compared with that before the dye incorporation. This confirmed that the dye was adsorbed in the interior of the pores.

The thus prepared mesoporous silica particles carrying the dye were classified, and the particles of a size of 2-3 nm were used as electrophoretic particles.

These particles, when dispersed in an insulating liquid same as that employed in Example 2, showed a satisfactory dispersibility to the insulating liquid without sedimentation of the particles when the liquid was left to stand. The electrophoretic particles prepared in this example were evaluated on the characteristics using the same electrophoretic apparatus and conditions as in Example 2. As a result, the electrophoretic particles of this example moved satisfactorily between the electrodes in an electric field applied thereto, showing satisfactory display performance. Almost no difference was observed in the characteristics, from the blue particles prepared in Example 4. It was also confirmed that no agglomeration of the particles occurred in the driving operation, whereby satisfactory driving performance were maintained over a prolonged period.

This example indicates that electrophoretic particles of different colors can be driven under the same conditions, if the mesoporous silica of the present invention is used.

### Comparative Example 4

Mesostructured silica particles were prepared employing a nonionic surfactant (Brij45) and calcined in the same manner as in Example 4 to obtain mesoporous silica particles. X-ray diffraction profile and nitrogen gas adsorption isotherm confirmed that the mesoporous silica had pores in a two-dimensional hexagonal structure and a specific surface area of 820 m²/g. 100 mg of the thus obtained mesoporous silica particles were dispersed in 30 g of a 0.075 wt % aqueous solution of Direct Blue 199, adjusted to pH 1.0, and were agitated for 1 hour with a magnetic stirrer for dye adsorption. Then, as in Example 4, the dispersion was separated by centrifugation, and re-dispersed in ethanol to eliminate the excess dye adsorbing on the outer surface. The mesoporous silica particles, obtained in this Comparative Example, showed scarce coloration, indicating that the dye was scarcely retained in the interior of the pores.

### Example 6

In this example, blue and yellow colorant particles were prepared where porous silica particles of an average diameter of about 180 nm were prepared using a cationic surfactant and the pores of the silica particles were modified with zirconium oxynitrate and blue and yellow dyes were adsirbed thereto, and these colored particles were applied to inks for an ink jet printer.

0.25 g of a cationic surfactant n-hexatridecyltrimethyl ammonium bromide (manufactured by Kishida Kagaku Co.) were dissolved in 78.2 ml of pure water, which was then added with 25.3 ml of a 30% ammonia aqueous solution and then 120 ml of ethanol, to obtain an alkaline solution of the surfactant in an ethanol-water mixture. The surfactant solution had a pH value of 12.2. The surfactant solution was heated to 70° C., then added with 0.35 ml of tetramethoxysilane, agitated for about 2 hours at 70° C., then transferred to a pressure-resistant container of which interior is lined with a fluorinated resin, and left to stand for about one day at 90° C. to obtain a precipitate. The precipitate was sufficiently rinsed with pure water and dried to obtain powder, which was calcined for 5 hours in an air atmosphere at 500° C.

From the X-diffraction, the powder was confirmed as mesoporous silica having pores in a two-dimensional hexagonal structure, with a (199) lattice distance of 3.8 nm.

As a result of nitrogen gas adsorption isotherm, the powder sample showed a specific surface area estimated to be 836 m²/g. The pore size distribution calculated by the BJH method showed that the pore size distribution was a distribution with a sharp single maximum at 2.2 nm and the distribution curve was within a range from 2 to 5 nm. These data confirmed that the prepared mesoporous silica had a substantially uniform pore size. Also observation by FE-SEM (field emission scanning electron microscope) confirmed that the particles were spherical particles of a substantially uniform size. Also the measurement of the particle size of the 20 particles in the FE-SEM images provided an evidence of the substantially uniform particle size. The estimated average particle size was 180 nm, with a minimum size of 140 nm, a maximum size of 200 nm. Further, the IR analysis confirmed that no organic components remained in the powder after the calcination.

The mesoporous silica particles were dispersed in a 10 wt % aqueous solution of zirconium oxynitrate, agitated for 3 hours at room temperature, then separated and sufficiently rinsed with ethanol. The rinsed particles were collected and dried at room temperature. Elemental analysis confirmed that the internal surface of the mesoporous silica was uniformed processed with zirconium oxynitrate. Also X-ray diffractometry of the processed powder showed a diffraction peak at the same position as with the powder immediately after the baking and before the processing, confirming that the pore structure was retained. Also a nitrogen gas adsorption experiment on the processed powder provided a specific surface area of 785 m²/g from the isothermal adsorption line, and the pore size distribution determined by the BJH method showed almost no change from that before the processing with zirconium oxynitrate.

Then an anionic dye was adsorbed to the mesoporous silica particles. An anionic phthalocyanine dye, Direct Blue 199, was used as a blue dye, and an anionic azo dye, Acid Yellow 23, was used as a yellow dye. 100 mg of the processed mesoporous silica particles were dispersed by ultrasonication in 5 ml of a 0.5 wt % aqueous solution of each dye, and were left to stand for 1 hour to introduce the dye into the pores. Then the particles containing the introduced dye were rinsed to wash off the excess dye adsorbing on the outer surface. The rinsing was conducted by repeating twice a process of dispersing the particles, carrying the dye, in ethanol, centrifuging the dispersion and discarding the supernatant rinsing liquid. This operation eliminated the excess dye adsorbing to the outer surface almost completely.

The rinsed particles were dried at room temperature to obtain mesoporous silica particles of vivid blue or yellow. CHN elemental analysis confirmed that the retained dye amount was 17% of the weight of the powder, for each of blue and yellow dyes, indicating sufficient retention.

X-ray diffractometry of the particles after the dye incorporation showed a diffraction peak in the same position as in the powder immediately after the baking, thereby confirming that the pore structure was retained. Also nitrogen gas adsorption measurement on the powder sample after the dye incorporation provided a specific surface area of 785 m²/g for the blue particles and 776 m²/g for the yellow particles, which was smaller than that before the dye incorporation. A pore size distribution determined by the BJH method from an isothermal adsorption line showed a maximum value almost same as that before the dye incorporation, but an increased proportion of pores of smaller sizes compared with that before the dye incorporation. This clearly indicated that the dye was incorporated in the interior of the pores.

Then, 100 mg each of these two kinds of dye-carrying mesoporous silica particles prepared above were respectively mixed with 2 ml of transparent ink bases shown in Table 1 and 2 in Example 1, and each mixture was dispersed by ultrasonication thereby obtaining blue and yellow inks.

The mesoporous silica particles in these inks did not show precipitation.

Then the blue and yellow inks prepared as above were filled in a cyan cartridge and an yellow cartridge respectively. Then the cartridges were set in a commercially available ink jet printer (BJ-S630, manufactured by Canon Inc.) connected to a personal computer.

After the head cleaning, printing was made on commercially available copy paper. The printed image was comprised of three portions, characters with the blue ink only, characters with the yellow ink only, and a checkerboard pattern with the blue ink and the yellow ink, prepared in advance on the personal computer.

The printed image was not perturbed, for example, by nozzle clogging, and printing was satisfactorily incorporated out until the inks were depleted.

First, the portions printed with blue color or yellow color were observed visually. Neither blotting nor line broadening was observed in each portion. Color mixing (bleeding) by ink blotting was hardly observed at the boundary of blue and yellow colors.

Next, a reference print of the same pattern was prepared using a dye-based cyan ink (trade name BCI-3eC, manufactured by Canon Inc.) and a dye-based yellow ink (trade name BCI-3eY, manufactured by Canon Inc.) using the same BJ-S630 printer, and the same copy paper. This reference print and the aforementioned print were subjected to the irradiation from a xenon lamp for 100 hours to determine weather resistance. As a result, the blue and yellow images formed with the inks containing the mesoporous silica particles showed weather resistance comparable to or better than that of the images formed with the aforementioned dye-based inks.

Based on these results, it was confirmed that the ink-jet ink employing the colorant particles prepared by modifying the pore surface with zirconium oxynitrate to incorporate an anionic dye thereon, could achieve a satisfactory printing, and the obtained print was free from blotting or bleeding and excellent in water resistance and weather resistance.

### Example 7

In this example, a color filter was prepared where a mesoporous silica film of an average thickness of about 1.0 μm was formed on a quartz glass substrate, then the internal wall of the pores of the silica film was modified with zirconium oxynitrate, and a dye was adsorbed thereon.

[Preparation of Substrate]

A quartz glass substrate of a dimension of 25×20 mm and a thickness of 1.0 mm was rinsed with acetone, isopropyl alcohol and pure water, and was surface cleaned with an ozone asher.

[Preparation of Mesoporous Silica Film]

0.828 ml of ethanol were mixed with 124 ml of 1N hydrochloric acid, and, after addition of 1.0 ml of tetraethoxysilane, the mixture was agitated for 20 minutes at 50° C. After the solution was cooled, there was added an aqueous surfactant solution, formed by dissolving 0.218 g of a nonionic surfactant, polyoxyethylene-10-cetyl ether (trade name: Briji56, manufactured by Sigma Chemical Inc.), in 0.389 ml of pure water. The obtained solution was agitated for 2 hours to obtain a precursor solution.

The precursor solution was applied on the quartz glass substrate at 3000 rpm and dried to obtain a thin film.

From the X-diffraction, the film was confirmed as a mesostructured silica film having a two-dimensional hexagonal structure, with a (199) lattice distance of 5.2 nm. Also the thickness, measured with a needle contact thickness measuring instrument (trade name: α-step, manufactured by Tencor Ltd.), was substantially uniform, 1.0 μm all over the substantially entire surface.

The substrate was calcined in an air atmosphere for 5 hours at 500° C. to eliminate the surfactant. From the X-diffraction of the film after the baking, it was confirmed that the (100) lattice distance was reduced to 3.5 nm, but the hexagonal porous structure was retained almost completely. Also the infrared absorption spectrum etc. confirmed that the organic component did not remain on the substrate after the elimination of the surfactant.

Also, such a film was prepared in plural units and scraped off to obtain a powder sample, and nitrogen gas adsorption isotherm conducted thereon confirmed that the powder sample showed a specific surface area estimated to be.964 m²/g as determined from the isothermal adsorption line. The pore size distribution calculated by the BJH method showed that the pore size distribution was a distribution with a sharp single maximum at 4.3 nm and the distribution curve was within a range from 3 to 7 nm. These data confirmed that the prepared mesoporous silica film had a substantially uniform pore size.

The pore wall of the mesoporous silica film was treated with zirconium oxynitrate in a process similar to that employed in Examples 1-3 for the powdered porous silica. More specifically, the mesoporous silica film on the substrate was immersed in a 10 wt % aqueous solution of zirconium oxynitrate, left to stand for 3 hours at room temperature, then sufficiently rinsed with pure water and dried at room temperature. A secondary ion mass spectroscopy confirmed that the outer and internal surface of the mesoporous silica was treated uniformly with zirconium oxynitrate.

X-ray diffractometry of the film after processing showed a diffraction peak at the same position as with the film immediately after the baking and before the treatment, confirming that the pore structure was retained. Also nitrogen gas adsorption measurement of the powder after the processing provided a specific surface area of 785 m²/g, and a pore size distribution determined by the BJH method showed a scarce change from the state before the treatment with zirconium oxynitrate.

Then an anionic dye was adsorbed to the mesoporous silica film. The mesoporous silica film processed as explained above was immersed in 10 ml of a 1.0 wt % aqueous solution of an anionic azo dye, Acid Red 52, and was left to stand for 1 hour for dye adsorption. Then the film was rinsed to wash off the excess dye adsorbing on the outer surface. The rinsing was conducted by repeating twice a process of immersing the dye-carrying substrate in ethanol. In this manner, a mesoporous silica film of dense purple (magenta) color was obtained on the substrate. Color unevenness was hardly observed in the film.

Such a film was scraped off, subjected to CHN elemental analysis, which confirmed that the amount of the dye in the film was 18% of the weight of the film, indicating sufficient carrying.

Optical absorbance of the thus prepared dye-retaining mesoporous silica film was measured by using a spectrophotometer (trade name: UV-3100, manufactured by Shimadzu Ltd.) to show an absorbance of about 0.8 at the absorption maximum, indicating that coloration was very strong. Also the weather resistance was examined by irradiating with a xenon lamp for 100 hours to show excellent weather resistance with little decrease in the absorbance by the light irradiation.

### Comparative Example 4

A mesoporous silica film was formed on a quartz glass substrate in the same manner as in Example 7, except that any modification was incorporated out.

The mesoporous silica on the substrate was immersed in 10 ml of a 1.0 wt % aqueous solution of Acid Red 52 employed in Example 7, and left to stand for 1 hour.

When the substrate taken out from the solution was rinsed with ethanol, the film became almost transparent, and the dye adsorption in the pores was not achieved.

1. A coloring material comprising a porous silica and an anionic dye held therein, wherein the porous silica has mesopores of a uniform diameter, and at least a part of which pore surface has been modified with a material having a function to bind an anionic dye.

2. The coloring material according to claim 1, wherein the material having a function to bind an anionic substance is a silane coupling agent having a cationic site.

3. The coloring material according to claim 2, wherein the silane coupling agent has an ammonium group.

4. The coloring material according to claim 2, wherein the silane coupling agent has an anion exchange ability.

5. The coloring material according to claim 2, wherein the silane coupling agent is N-trimethoxysilylpropyl-N,N,N-trimethyl ammonium chloride.

6. The coloring material according to claim 1, wherein the material having a function to bind an anionic substance includes a compound having a bond of oxygen and a metal element that forms an oxide having an isoelectric point higher than that of silica.

7. The coloring material according to claim 6, wherein the metal element that forms an oxide having an isoelectric point higher than that of silica is zirconium.

8. The coloring material according to claim 1, wherein the mesopores of a uniform diameter are formed utilizing a molecular assembly of an amphiphilic substance as a template.

9. The coloring material according to claim 8, wherein the amphiphilic substance is a surfactant.

10. The coloring material according to claim 1, wherein the size distribution of the mesopores, determined by nitrogen gas adsorption measurement, has a single maximum and 60% or more of the pores are included within a width of 10 nm or less in the pore size distribution.

11. The coloring material according to claim 1, wherein the coloring material is in a powder form.

12. An ink comprising a coloring material of claim 1.

13. An electrophoretic particle comprising a coloring material of claim 1.

14. An electrophoretic display apparatus comprising electrophoretic particles comprising a coloring material of claim 1, a dispersion medium for dispersing the electrophoretic particles, and a pair of electrodes for driving the electrophoretic particles.

15. The coloring material according to claim 1, wherein the coloring material is in a film form.

16. A color filter comprising a coloring material of claim 1.

17. A method for producing a coloring material comprising the steps of:
hydrolyzing and condensing a substance being a silica source in the presence of an amphiphilic substance thereby preparing a precursor of a porous silica comprising a composite of silica and an organic substance;
eliminating the amphiphilic substance from the precursor thereby obtaining a porous silica;
modifying at least a part of the pore surface of the porous silica with a material having a function to bind an anionic substance; and
carrying an anionic dye to the porous silica.

18. The producing method according to claim 17, wherein the step of modifying at least a part of the pore surface of the porous silica with a material having a function to bind an anionic substance comprises a step of coupling a silane coupling agent having a cationic site with at least a part of the pore surface of the porous silica.

19. The producing method according to claim 17, wherein the step of modifying at least a part of the pore surface of the porous silica with a material having a function to bind an anionic substance comprises a step of processing the pore surface of the porous silica with a solution of N-trimethoxysilylpropyl-N,N,N-trimethyl ammonium chloride.

20. The producing method according to claim 17, wherein the step of modifying at least a part of the pore surface of the porous silica with a material having a function to bind an anionic substance comprises a step of forming on at least a portion of the pore surface of the porous silica, a compound having a bond of oxygen and a metal element that forms an oxide having an isoelectric point higher than that of silica.

21. The producing method according to claim 17, wherein the step of modifying at least a part of the pore surface of the porous silica with a material having a function to bind an anionic substance comprises a step of treating the pore surface of the porous silica with an aqueous solution of zirconium oxynitrate.
